(19) United States
(12) Patent Application Publication
(10) Pub. No.: US 2026/0257214 A1
(43) Pub. Date: Sep. 3, 2026

(54) RECYCLING OF HOMOGENEOUS PALLADIUM CATALYST

(71) Applicant: FIRMENICH SA, Satigny (CH)

(72) Inventor: Thomas JERPHAGNON, Satigny (CH)

(21) Appl. No.: 19/491,222

(22) PCT Filed: Jun. 20, 2024
(86) PCT No.: PCT/EP2024/067232

§ 371 Date: Dec. 8, 2025

(30) Foreign Application Priority Data
Jun. 28, 2023 (EP) 23182030.9

(51) Int. Cl. B01J 37/28; B01D 3/06; B01J 31/24; B01J 31/40

(52) U.S. Cl. CPC B01J 37/28; B01D 3/06; B01J 31/2409; B01J 31/4053

(57) ABSTRACT

The present invention relates to the field of catalysis and, more particularly, to methods for recovering palladium in a form of a homogeneous palladium complex of formula (I) from a reaction mixture comprising a homogeneous palladium complex.

### TECHNICAL FIELD

The present invention relates to the field of catalysis and, more particularly, to methods for recovering palladium in a form of a homogeneous palladium complex of formula (I) from a reaction mixture comprising a homogeneous palladium complex.

### BACKGROUND

In organic chemistry, one of a major breakthrough was the discovery of catalysed reactions, in particular the reactions performed in the presence of a metal complex acting as a catalyst. Said discovery allows since decades to develop novel reactions such as cross-coupling, C—H activation, addition to unsaturated bond, intra or intermolecular cyclisation, elimination, allylic substitution, hydrogenation, hydroformylation or isomerization. Homogeneous palladium complex represents one of the catalysts widely developed and the most employed.

Awareness of climate and environment issues increases and the development of such type of reaction falls within this trend. Indeed, metal-complex catalysed reactions represents one of the twelve principles of green chemistry aiming at reducing the environmental impact of organic chemistry. The reduction of the waste generated during a chemical reaction is also highly sought. The homogeneous palladium complexes involved in such reactions are part of the waste and are note necessary recovered at the end of the reaction.

Today, there is a need to limit the waste and to recover/recycle as much as possible the metal complex although only a small amount is involved in such transformation.

The present invention allows recovering palladium in a form of a homogeneous palladium complex of formula (I) from a reaction mixture comprising a homogeneous palladium complex by adding phosphine during the distillation of the reaction mixture or in the distillation residue. To the best of our knowledge, the invention's method has never been reported in the prior art.

### DESCRIPTION OF THE INVENTION

Surprisingly, the present invention's methods allow recovering palladium in a form of a homogeneous palladium complex of formula (I) in an easy and highly productive manner.

So a first object of the present invention is a method for recovering palladium in a form of a palladium complex of formula (I)

$${Pd ( {PR}_{3}^{1} )}_{x} {( {PR}_{3}^{2} )}_{y} \qquad ( I )$$

wherein x is an integer comprised between 1 and 4; y is a integer comprised between 0 and 3 provided that the sum between x and y is equal to 4; each R¹, independently from each other, is a C₁-C₁₂ alkyl group, a C₁-C₁₂ alkoxy group, a C₆-C₁₂ aryloxy group or a C₆-C₁₂ aryl group; each optionally substituted by one or more of a halogen atom, a C₁₋₆ alkyl group, a C₁₋₆ alkoxy group, a hydroxy group, a N—C₁₋₆ alkylaniline group, N—C₁₋₆ alkyl-N—C₁₋₆ alkylaniline group or a C₁₋₆ halo- or perhalo hydrocarbon; each R², independently from each other, is a C₁-C₁₂ alkyl group, a C₁-C₁₂ alkoxy group, a C₆-C₁₂ aryloxy group or a C₆-C₁₂ aryl group; each optionally substituted by one or more of a halogen atom, a C₁₋₆ alkyl group, a C₁₋₆ alkoxy group, a hydroxy group, a N—C₁₋₆ alkylaniline group, N—C₁₋₆ alkyl-N—C₁₋₆ alkylaniline group or a C₁₋₆ halo- or perhalo hydrocarbon; and provided that PR¹₃ is different from PR²₃;
   from a reaction mixture comprising a homogeneous palladium complex; said method comprises the step of
a) adding to the reaction mixture at least one phosphine of formula PR¹₃ wherein R¹ as the same meaning as defined above and optionally another phosphine of formula PR²₃ wherein R² as the same meaning as defined above;
b) distilling the reaction mixture obtained from step a) to obtain a distillate and a distillation residue; and
c) filtrate the distillation residue to obtain the palladium complex of formula (I).

For the sake of clarity, by the expression “x is an integer comprised between 1 and 4; y is a integer comprised between 0 and 3 provided that the sum between x and y is equal to 4”, or the similar, it is meant the normal meaning understood by a person skilled in the art, i.e. x may be 1, 2, 3 or 4 and y may be 0, 1, 2 or 3 and x+y is equal to 4. For example, when x is 4, then y is 0 or when x is 2 then y is 2 or when x is 3, then y is 1.

The terms “alkyl”, “alkoxy”, “N—C₁₋₆ alkylaniline group” and N—C₁₋₆ alkyl-N—C₁₋₆ alkylaniline group are understood as comprising branched and linear alkyl, alkoxy, N—C₁₋₆ alkylaniline and N—C₁₋₆ alkyl-N—C₁₋₆ alkylaniline groups.

The term “N—C₁₋₆ alkylaniline” is understood as a secondary amine of formula —NH—R′ wherein R′ is a C₁₋₆ alkyl group.

The term “N—C₁₋₆ alkyl-N—C₁₋₆ alkylaniline” is understood as a tertiary amine of formula —NR′R″ wherein R′ and R″, independently from each other, are a C₁₋₆ alkyl group.

The term “aryl” is understood as comprising any group comprising at least one aromatic group such as phenyl, indenyl, indanyl, benzodioxolyl, dihydrobenzodioxinyl, tetrahydronaphthalenyl or naphthalenyl group.

The term “optionally” is understood that a certain group to be optionally substituted can or cannot be substituted with a certain functional group. The term “one or more” is understood as being substituted with 1 to 7, preferably 1 to 5 and more preferably 1 to 3 of a certain functional group.

The terms “halo- or perhalo-hydrocarbon” are understood as hydrocarbon group wherein a hydrogen atom or all hydrogen atoms have been replaced by halogen atoms. Example of “halo- or perhalo-hydrocarbon” are CClH₂ or CF₃.

Alternatively, the at least one phosphine of formula PR¹₃ and optionally another phosphine of formula PR²₃ may be added after the distillation to the distillation residue. So a second object of the invention is a method for recovering palladium in a form of a palladium complex of formula (I)

$${Pd ( {PR}_{3}^{1} )}_{x} {( {PR}_{3}^{2} )}_{y} \qquad ( I )$$

wherein x is an integer comprised between 1 and 4; y is a integer comprised between 0 and 3 provided that the sum between x and y is equal to 4; each R¹, independently from each other, is a C₁-C₁₂ alkyl group, a C₁-C₁₂ alkoxy group, a C₆-C₁₂ aryloxy group or a C₆-C₁₂ aryl group; each optionally substituted by one or more of a halogen atom, a C₁₋₆ alkyl group, a C₁₋₆ alkoxy group, a hydroxy group, a N—C₁₋₆ alkylaniline group, N—C₁₋₆ alkyl-N—C₁₋₆ alkylaniline group or a C₁₋₆ halo- or perhalo hydrocarbon; each R², independently from each other, is a C₁-C₁₂ alkyl group, a C₁-C₁₂ alkoxy group, a C₆-C₁₂ aryloxy group or a C₆-C₁₂ aryl group; each optionally substituted by one or more of a halogen atom, a C₁₋₆ alkyl group, a C₁₋₆ alkoxy group, a hydroxy group, a N—C₁₋₆ alkylaniline group, N—C₁₋₆ alkyl-N—C₁₋₆ alkylaniline group or a C₁₋₆ halo- or perhalo hydrocarbon; and provided that PR¹₃ is different from PR²₃;
   from a reaction mixture comprising a homogeneous palladium complex; said method comprises the step of
i) distilling the reaction mixture comprising the homogeneous palladium complex to obtain a distillate and a distillation residue;
ii) adding to the distillation residue at least one phosphine of formula PR¹₃ wherein R¹ as the same meaning as defined above and optionally another phosphine of formula PR²₃ wherein R² as the same meaning as defined above;
iii) mixing the distillation residue comprising phosphine obtained from step ii) to obtain a distillation residue comprising the palladium complex of formula (I); and iv) filtrate the distillation residue comprising the palladium complex of formula (I) to obtain the palladium complex of formula (I).

The terms “reaction mixture comprising a homogeneous palladium complex” is understood as any mixture resulting from
1) a chemical synthesis/reaction wherein a homogeneous palladium complex is used as a reagent, in particular as a catalyst, providing a crude; and
2) the crude as obtained in step 1) is optionally washed by one or more washing steps to obtain the reaction mixture comprising palladium.
   The washing steps may be that the crude is washed with water, one or more acidic aqueous solutions and/or one or more basic aqueous solutions. The crude may be washed several times and by different kind of aqueous solution. In other words, a palladium-catalysed reaction is carried out under conditions known by the person skilled in the art. The crude of the reaction obtained is optionally washed with water, one or more acidic aqueous solutions and/or one or more basic aqueous solutions to provide a reaction mixture comprising a homogeneous palladium complex. Then, the invention's methods are performed on the reaction mixture as such obtained. The palladium-catalysed reaction may be any reaction catalysed by a homogeneous palladium complex. Examples of suitable palladium-catalysed reaction include, but are not limited to, cross-coupling such as Heck reaction, Sonogashira coupling, Negishi coupling, Stille cross coupling, Suzuki coupling, Kumada coupling, Hiyama coupling, Buchwald-Hartwig coupling, cyanation reaction, carbonylation reaction, C—H activation, addition to unsaturated bond, intra or intermolecular cyclisation, allylic substitution, elimination. The palladium complex used in such reaction is a homogeneous palladium (0), palladium (I) or palladium (II) complex. Examples of suitable homogeneous palladium (0) include, but are not limited to, palladium tetrakistriarylphosphine, palladium diphosphine, palladium triphosphine, bis(dibenzylideneacetone)palladium or tris(dibenzylideneacetone)-dipalladium. Examples of suitable homogeneous palladium (I) include, but are not limited to, monophosphine palladium halide dimer. Examples of suitable homogeneous palladium (II) include, but are not limited to, palladium acetate; palladium acetylacetonate, allylpalladium chloride dimer, crotylpalladium chloride dimer, cinnamylpalladium chloride dimer, dihalobis(acetonitrile)palladium, dihalobis(benzonitrile)palladium, dichlorobisphosphinepalladium, diphosphine palladium acetate, dichlorodiphosphinepalladium, dihalo(1,5-cyclooctadiene)palladium or dihalo(1,10-phenanthroline)palladium.

It is important to stress, that for the present invention said reaction mixture is not a result from the preparation reaction of a palladium complex per se, particular of the palladium complex of the formula (I).

According to any embodiment of the invention, the palladium complex of formula (I) and the homogeneous palladium complex from the reaction mixture may be identic or different, particularly different.

According to a particular embodiment of the invention, the reaction mixture comprising a homogeneous palladium complex results from a reaction catalysed with a homogeneous palladium (II) or a homogeneous palladium (0) complex, in particular palladium acetate or palladium tetrakistriphenylphosphine.

According to any embodiment of the invention, the distillation is performed with a distillation column which may comprise plates or trays or packing material. A person skilled in the art is able to select and sized the distillation column as a function of the melting and boiling point of the starting and final products.

According to any embodiment of the invention, the distillation may be carried out at atmospheric pressure or at reduced pressure, in particular at a pressure of less than 5×10⁴ Pa (500 mbars), for example at a pressure comprised between 100 Pa and 5×10⁴ Pa (1 and 500 mbars).

According to any embodiment of the invention, the distillation may be carried out at a temperature comprised between 40° C. and 300° C., more preferably in the range of between 80° C. and 250° C. Of course, a person skilled in the art is also able to select the preferred temperature as a function of the boiling point of the starting and final products as well as the boiling point of the solvent.

According to any embodiment of the invention, the distillation is performed in the presence of a solvent having a high boiling point. Said solvent is inert. Particularly, the solvent has a boiling point above 200° C., even above 300° C. Examples of suitable solvent having a high boiling point include, but are not limited to, polyethylene glycol, dibenzyl-toluene, high boiling point saturated and unsaturated hydrocarbons.

According to any embodiment of the invention, the solvent having a high boiling point can be added to the distillation medium in a large range of concentrations. As non-limiting examples, one can cite as solvent having a high boiling point concentration values those ranging from 1 to 100 equivalents, relative to the amount of the homogeneous palladium complex comprised in the reaction mixture. Preferably, the solvent having a high boiling point concentration will be comprised between from 4 to 50 equivalents. Even more preferably, the solvent having a high boiling point concentration will be comprised between from 5 to 20 equivalents. It goes without saying that the invention's method works also with more solvent having a high boiling point. However the optimum concentration of the solvent having a high boiling point will depend, as the person skilled in the art knows, on the nature of the latter, on the nature of the palladium complex, on the temperature and on the desired time of reaction.

The temperature at wish the mixing of the distillation residue comprising phosphine obtained from step ii) can be carried out is comprised between 20° C. and 100° C., more preferably in the range of between 50° C. and 90° C. Of course, a person skilled in the art is also able to select the preferred temperature as a function of the nature of the distillation residue and the nature of the phosphines used.

According to any embodiment of the invention, the mixing of the distillation residue comprising phosphine obtained from step ii) is carried out under inert atmosphere, such as nitrogen or argon.

According to any embodiment of the invention, the mixing of the distillation residue comprising phosphine obtained from step ii) is carried out over a period of 30 to 240 minutes, preferably 60 to 150 minutes.

According to any embodiment of the invention, the filtration is a gravity filtration, a membrane filtration or a vacuum filtration.

According to any embodiment of the invention, the palladium complex of formula (I) obtained after the filtration is further washed with organic solvent. Examples of suitable solvent for the washing of the palladium complex of formula (I) include, but are not limited to, aromatic solvents toluene, fluoro-benzene, trifluoro-toluene, ortho-difluoro-benzene, ortho-dichloro-benzene, chlorobenzene or xylene, hydrocarbon solvents such as hexane, heptane or cyclohexane, ethers such as tetrahydrofuran, methyltetrahydrofuran or MTBE, polar solvents such as primary or secondary alcohols such as isopropanol, ethanol or methanol, or mixtures thereof.

According to any embodiment of the invention, the method of the invention is performed in absence of base, additive, reductive agent or oxidative agent.

According to any embodiment of the invention, the phosphine of formula PR¹₃ can be added to the reaction medium in a large range of concentrations. As non-limiting examples, one can cite as complex concentration values those ranging from 4 to 15 equivalents, relative to the amount of the homogeneous palladium complex comprised in the reaction mixture. Preferably, the phosphine concentration will be comprised between from 4 to 10 equivalents. Even more preferably, the phosphine concentration will be comprised between from 5 to 8 equivalents. It goes without saying that the invention's method works also with more phosphine. However the optimum concentration of the phosphine of formula PR¹₃ will depend, as the person skilled in the art knows, on the nature of the latter, on the nature of the palladium complex, on the temperature and on the desired time of reaction.

According to any embodiment of the invention, the phosphine of formula PR²₃ can be added to the reaction medium in a large range of concentrations. As non-limiting examples, one can cite as complex concentration values those ranging from 0 to 15 equivalents, relative to the amount of the homogeneous palladium complex comprised in the reaction mixture. Preferably, the phosphine concentration will be comprised between from 0 to 10 equivalents. Even more preferably, the phosphine concentration will be comprised between from 0 to 8 equivalents. It goes without saying that the invention's method works also with more phosphine. However the optimum concentration of the phosphine of formula PR²₃ will depend, as the person skilled in the art knows, on the nature of the latter, on the nature of the palladium complex, on the temperature and on the desired time of reaction.

According to any embodiment of the invention, each R², independently from each other, is a C₁-C₁₀ alkyl group, a C₁-C₁₀ alkoxy group, a C₆-C₁₀ aryloxy group or a C₆-C₁₀ aryl group; each optionally substituted by one or more of a halogen atom, a C₁₋₆ alkyl group, a C₁₋₆ alkoxy group, a hydroxy group, a N—C₁₋₆ alkylaniline group, N—C₁₋₆ alkyl-N—C₁₋₆ alkylaniline group or a C₁₋₆ halo- or perhalo hydrocarbon. Particularly, each R², independently from each other, is a C₁-C₈ alkyl group, a C₁-C₈ alkoxy group, a C₆-C₁₀ aryloxy group or a C₆-C₁₀ aryl group; each optionally substituted by one or more of a halogen atom, a C₁₋₆ alkyl group, a C₁₋₆ alkoxy group, a hydroxy group, a N—C₁₋₆ alkylaniline group, N—C₁₋₆ alkyl-N—C₁₋₆ alkylaniline group, or a C₁₋₆ halo- or perhalo hydrocarbon. Particularly, each R², independently from each other, is a C₁-C₆ alkyl group, a C₁-C₆ alkoxy group, a C₆-C₁₀ aryloxy group or a C₆-C₁₀ aryl group; each optionally substituted by one or more of a halogen atom, a C₁₋₆ alkyl group, a C₁₋₆ alkoxy group, a hydroxy group, a N—C₁₋₆ alkylaniline group, N—C₁₋₆ alkyl-N—C₁₋₆ alkylaniline group or a C₁₋₆ halo- or perhalo hydrocarbon. Particularly, each R², independently from each other, is a C₁-C₆ alkyl group, a C₁-C₆ alkoxy group, a C₆-C₁₀ aryloxy group or a C₆-C₁₀ aryl group; each optionally substituted by one or more of a halogen atom, a C₁₋₄ alkyl group, a C₁₋₄ alkoxy group, a hydroxy group, a N—C₁₋₄ alkylaniline group, N—C₁₋₄ alkyl-N—C₁₋₄ alkylaniline group or a C₁₋₄ halo- or perhalo hydrocarbon. Particularly, each R², independently from each other, is a C₁-C₄ alkyl group, a C₁-C₄ alkoxy group, a C₆-C₁₀ aryloxy group or a C₆-C₁₀ aryl group; each optionally substituted by one or more of a halogen atom, a C₁₋₄ alkyl group, a C₁₋₄ alkoxy group, a hydroxy group, a N—C₁₋₄ alkylaniline group, N—C₁₋₄ alkyl-N—C₁₋₄ alkylaniline group or a C₁₋₄ halo- or perhalo hydrocarbon. Particularly, each R², independently from each other, is a C₁-C₃ alkyl group, a C₁-C₃ alkoxy group, a C₆-C₁₀ aryloxy group or a C₆-C₁₀ aryl group; each optionally substituted by one or more of a halogen atom, a C₁₋₄ alkyl group, a C₁₋₄ alkoxy group, a hydroxy group, a N—C₁₋₄ alkylaniline group, N—C₁₋₄ alkyl-N—C₁₋₄ alkylaniline group or a C₁₋₄ halo- or perhalo hydrocarbon. Particularly, each R², independently from each other, is a C₁-C₂ alkyl group, a C₁-C₂ alkoxy group, a C₆-C₁₀ aryloxy group or a C₆-C₁₀ aryl group; each optionally substituted by one or more of a halogen atom, a C₁₋₄ alkyl group, a C₁₋₄ alkoxy group, a hydroxy group, a N—C₁₋₄ alkylaniline group, N—C₁₋₄ alkyl-N—C₁₋₄ alkylaniline group or a C₁₋₄ halo- or perhalo hydrocarbon. Particularly, each R², independently from each other, is a methyl group, a C₆-C₁₀ aryloxy group or a C₆-C₁₀ aryl group; each optionally substituted by one or more of a halogen atom, a C₁₋₄ alkyl group, a C₁₋₄ alkoxy group, a hydroxy group, a N—C₁₋₄ alkylaniline group, N—C₁₋₄ alkyl-N—C₁₋₄ alkylaniline group or a C₁₋₄ halo- or perhalo hydrocarbon. Particularly, each R², independently from each other, is a methyl group, a C₆ aryloxy group or a C₆ aryl group; each optionally substituted by one or more of a halogen atom, a C₁₋₄ alkyl group, a C₁₋₄ alkoxy group, a hydroxy group, a N—C₁₋₄ alkylaniline group, N—C₁₋₄ alkyl-N—C₁₋₄ alkylaniline group or a C₁₋₄ halo- or perhalo hydrocarbon. Particularly, each R², independently from each other, is a methyl group or a phenyl group optionally substituted by one or more of a halogen atom, a C₁₋₄ alkyl group, a C₁₋₄ alkoxy group, a hydroxy group, a N—C₁₋₄ alkylaniline group, N—C₁₋₄ alkyl-N—C₁₋₄ alkylaniline group or a C₁₋₄ halo- or perhalo hydrocarbon. Particularly, each R², independently from each other, is a methyl group or a phenyl group optionally substituted by one or more of a halogen atom, a C₁₋₃ alkyl group, a C₁₋₃ alkoxy group, a hydroxy group, a N—C₁₋₃ alkylaniline group, N—C₁₋₃ alkyl-N—C₁₋₃ alkylaniline group or a C₁₋₃ halo- or perhalo hydrocarbon. Particularly, each R², independently from each other, is a methyl group or a phenyl group optionally substituted by one or more of a halogen atom, a C₁₋₂ alkyl group a C₁₋₂ alkoxy group, a hydroxy group, a N—C₁₋₂ alkylaniline group, N—C₁₋₂ alkyl-N—C₁₋₂ alkylaniline group or a perhalo hydrocarbon. Particularly, each R², independently from each other, is a methyl group or a phenyl group optionally substituted by one or more of a halogen atom, a C₁₋₂ alkyl group a C₁₋₂ alkoxy group or a perhalo hydrocarbon. Particularly, each R², independently from each other, is a methyl group or a phenyl group optionally substituted by one or more of a chlorine atom, fluorine atom, bromine atom, a methyl group a methoxy group, a N,N-dimethylaniline, a hydroxy group or a trifluoromethyl group. Particularly, each R², independently from each other, is a methyl group, a phenyl group, a o-methoxyphenyl group, a m-methoxyphenyl group, a p-methoxyphenyl group, a o-tolyl group, a m-tolyl group, a p-tolyl group, a 4-methoxy-3,5-dimethylphenyl group, a 2,4-dimethylphenyl group, a 3,5-dimethylphenyl group, a 2,4,6-trimethoxyphenyl group, a pentafluorophenyl group, a m-chlorophenyl group, a p-chlorophenyl group, a p-fluorophenyl group, a p-trifluoromethylphenyl group, a 4-(N,N-dimethylamino)phenyl group, a 2-hydroxyphenyl group, a 2-bromophenyl group, a 2,4,6-trimethylphenyl group.

According to any embodiment of the invention, PR²₃ may be selected from the group consisting of triphenyl phosphine, tris(o-methoxyphenyl)phosphine, tris(m-methoxyphenyl)phosphine, tris(p-methoxyphenyl)phosphine, tri(o-tolyl)phosphine, tri(m-tolyl)phosphine, tri(p-tolyl)phosphine, tris(4-methoxy-3,5-dimethylphenyl)phosphine, methyl(diphenyl)phosphane, tris(2,4-dimethylphenyl)phosphine, tris(3,5-dimethylphenyl)phosphine, tris(2,4,6-trimethoxyphenyl)phosphine, tris(pentafluorophenyl)phosphine, tri(m-chlorophenyl)phosphine, tri(p-chlorophenyl)phosphine, tris(p-fluorophenyl)phosphine, tris(p-trifluoromethylphenyl)phosphine, diphenyl[4-(N,N-dimethylamino)phenyl]phosphine, (2-hydroxyphenyl)diphenylphosphine, 2-bromophenyldiphenylphosphine, tris(2,4,6-trimethylphenyl)phosphine.

According to any embodiment of the invention, x is 2, 3 or 4. Preferably, x is 4.

According to any embodiment of the invention, y is 2, 1 or 0. Preferably, y is 0.

According to any embodiment of the invention, the palladium complex of formula (I) is of formula

$${Pd ( {PR}_{3}^{1} )}_{4} \qquad ( I ’ )$$

Wherein x and R¹ have the same meaning as defined above.

According to any embodiment of the invention, each R¹, independently from each other, is a C₁-C₁₀ alkyl group, a C₁-C₁₀ alkoxy group, a C₆-C₁₀ aryloxy group or a C₆-C₁₀ aryl group; each optionally substituted by one or more of a halogen atom, a C₁₋₆ alkyl group, a C₁₋₆ alkoxy group, a hydroxy group, a N—C₁₋₆ alkylaniline group, N—C₁₋₆ alkyl-N—C₁₋₆ alkylaniline group or a C₁₋₆ halo- or perhalo hydrocarbon. Particularly, each R¹, independently from each other, is a C₁-C₅ alkyl group, a C₁-C₅ alkoxy group, a C₆-C₁₀ aryloxy group or a C₆-C₁₀ aryl group; each optionally substituted by one or more of a halogen atom, a C₁₋₆ alkyl group, a C₁₋₆ alkoxy group, a hydroxy group, a N—C₁₋₆ alkylaniline group, N—C₁₋₆ alkyl-N—C₁₋₆ alkylaniline group, or a C₁₋₆ halo- or perhalo hydrocarbon. Particularly, each R¹, independently from each other, is a C₁-C₆ alkyl group, a C₁-C₆ alkoxy group, a C₆-C₁₀ aryloxy group or a C₆-C₁₀ aryl group; each optionally substituted by one or more of a halogen atom, a C₁₋₆ alkyl group, a C₁₋₆ alkoxy group, a hydroxy group, a N—C₁₋₆ alkylaniline group, N—C₁₋₆ alkyl-N—C₁₋₆ alkylaniline group or a C₁₋₆ halo- or perhalo hydrocarbon. Particularly, each R¹, independently from each other, is a C₁-C₆ alkyl group, a C₁-C₆ alkoxy group, a C₆-C₁₀ aryloxy group or a C₆-C₁₀ aryl group; each optionally substituted by one or more of a halogen atom, a C₁₋₄ alkyl group, a C₁₋₄ alkoxy group, a hydroxy group, a N—C₁₋₄ alkylaniline group, N—C₁₋₄ alkyl-N—C₁₋₄ alkylaniline group or a C₁₋₄ halo- or perhalo hydrocarbon. Particularly, each R¹, independently from each other, is a C₁-C₄ alkyl group, a C₁-C₄ alkoxy group, a C₆-C₁₀ aryloxy group or a C₆-C₁₀ aryl group; each optionally substituted by one or more of a halogen atom, a C₁₋₄ alkyl group, a C₁₋₄ alkoxy group, a hydroxy group, a N—C₁₋₄ alkylaniline group, N—C₁₋₄ alkyl-N—C₁₋₄ alkylaniline group or a C₁₋₄ halo- or perhalo hydrocarbon. Particularly, each R¹, independently from each other, is a C₁-C₃ alkyl group, a C₁-C₃ alkoxy group, a C₆-C₁₀ aryloxy group or a C₆-C₁₀ aryl group; each optionally substituted by one or more of a halogen atom, a C₁₋₄ alkyl group, a C₁₋₄ alkoxy group, a hydroxy group, a N—C₁₋₄ alkylaniline group, N—C₁₋₄ alkyl-N—C₁₋₄ alkylaniline group or a C₁₋₄ halo- or perhalo hydrocarbon. Particularly, each R¹, independently from each other, is a C₁-C₂ alkyl group, a C₁-C₂ alkoxy group, a C₆-C₁₀ aryloxy group or a C₆-C₁₀ aryl group; each optionally substituted by one or more of a halogen atom, a C₁₋₄ alkyl group, a C₁₋₄ alkoxy group, a hydroxy group, a N—C₁₋₄ alkylaniline group, N—C₁₋₄ alkyl-N—C₁₋₄ alkylaniline group or a C₁₋₄ halo- or perhalo hydrocarbon. Particularly, each R¹, independently from each other, is a methyl group, a C₆-C₁₀ aryloxy group or a C₆-C₁₀ aryl group; each optionally substituted by one or more of a halogen atom, a C₁₋₄ alkyl group, a C₁₋₄ alkoxy group, a hydroxy group, a N—C₁₋₄ alkylaniline group, N—C₁₋₄ alkyl-N—C₁₋₄ alkylaniline group or a C₁₋₄ halo- or perhalo hydrocarbon. Particularly, each R¹, independently from each other, is a methyl group, a C₆ aryloxy group or a C₆ aryl group; each optionally substituted by one or more of a halogen atom, a C₁₋₄ alkyl group, a C₁₋₄ alkoxy group, a hydroxy group, a N—C₁₋₄ alkylaniline group, N—C₁₋₄ alkyl-N—C₁₋₄ alkylaniline group or a C₁₋₄ halo- or perhalo hydrocarbon. Particularly, each R¹, independently from each other, is a methyl group or a phenyl group optionally substituted by one or more of a halogen atom, a C₁₋₄ alkyl group, a C₁₋₄ alkoxy group, a hydroxy group, a N—C₁₋₄ alkylaniline group, N—C₁₋₄ alkyl-N—C₁₋₄ alkylaniline group or a C₁₋₄ halo- or perhalo hydrocarbon. Particularly, each R¹, independently from each other, is a methyl group or a phenyl group optionally substituted by one or more of a halogen atom, a C₁₋₃ alkyl group, a C₁₋₃ alkoxy group, a hydroxy group, a N—C₁₋₃ alkylaniline group, N—C₁₋₃ alkyl-N—C₁₋₃ alkylaniline group or a C₁₋₃ halo- or perhalo hydrocarbon. Particularly, each R¹, independently from each other, is a methyl group or a phenyl group optionally substituted by one or more of a halogen atom, a C₁₋₂ alkyl group a C₁₋₂ alkoxy group, a hydroxy group, a N—C₁₋₂ alkylaniline group, N—C₁₋₂ alkyl-N—C₁₋₂ alkylaniline group or a perhalo hydrocarbon. Particularly, each R¹, independently from each other, is a methyl group or a phenyl group optionally substituted by one or more of a halogen atom, a C₁₋₂ alkyl group a C₁₋₂ alkoxy group or a perhalo hydrocarbon. Particularly, each R¹, independently from each other, is a methyl group or a phenyl group optionally substituted by one or more of a chlorine atom, fluorine atom, bromine atom, a methyl group a methoxy group, a N,N-dimethylaniline, a hydroxy group or a trifluoromethyl group. Particularly, each R¹, independently from each other, is a methyl group, a phenyl group, a o-methoxyphenyl group, a m-methoxyphenyl group, a p-methoxyphenyl group, a o-tolyl group, a m-tolyl group, a p-tolyl group, a 4-methoxy-3,5-dimethylphenyl group, a 2,4-dimethylphenyl group, a 3,5-dimethylphenyl group, a 2,4,6-trimethoxyphenyl group, a pentafluorophenyl group, a m-chlorophenyl group, a p-chlorophenyl group, a p-fluorophenyl group, a p-trifluoromethylphenyl group, a 4-(N,N-dimethylamino)phenyl group, a 2-hydroxyphenyl group, a 2-bromophenyl group, a 2,4,6-trimethylphenyl group. Even more particularly, each R¹, independently from each other, is a phenyl group.

According to any embodiment of the invention, PR¹₃ may be selected from the group consisting of triphenyl phosphine, tris(o-methoxyphenyl)phosphine, tris(m-methoxyphenyl)phosphine, tris(p-methoxyphenyl)phosphine, tri(o-tolyl)phosphine, tri(m-tolyl)phosphine, tri(p-tolyl)phosphine, tris(4-methoxy-3,5-dimethylphenyl)phosphine, methyl(diphenyl)phosphane, tris(2,4-dimethylphenyl)phosphine, tris(3,5-dimethyl-phenyl)phosphine, tris(2,4,6-trimethoxyphenyl)phosphine, tris(pentafluorophenyl)-phosphine, tri(m-chlorophenyl)phosphine, tri(p-chlorophenyl)phosphine, tris(p-fluorophenyl)phosphine, tris(p-trifluoromethylphenyl)phosphine, diphenyl[4-(N,N-dimethylamino)phenyl]phosphine, (2-Hydroxyphenyl)diphenylphosphine, 2-Bromophenyldiphenylphosphine, tris(2,4,6-trimethylphenyl)phosphine. Particularly, PR¹₃ is triphenyl phosphine.

According to any embodiment of the invention, the palladium complex of formula (I′) may be selected from the group consisting of palladium tetrakis(triphenylphosphine), tri(tris(o-methoxyphenyl)phosphine)phosphine, palladium tetrakis(tris(m-methoxy-phenyl)phosphine), palladium tetrakis(tris(p-methoxyphenyl)phosphine), palladium tetrakis(tri(p-tolyl)phosphine), palladium tetrakis(tris(4-methoxy-3,5-dimethyl-phenyl)phosphine), palladium tetrakis(methyl(diphenyl)phosphane), palladium tetrakis(tris(2,4-dimethylphenyl)phosphine), palladium tetrakis(tris(3,5-dimethyl-phenyl)phosphine), palladium tetrakis(tris(2,4,6-trimethoxyphenyl)phosphine), palladium tetrakis(tris(pentafluorophenyl)phosphine), palladium tetrakis(tri(m-chlorophenyl)-phosphine), palladium tetrakis(tri(p-chlorophenyl)phosphine), palladium tetrakis(tris(p-fluorophenyl)phosphine), palladium tetrakis(tris(p-trifluoromethylphenyl)phosphine), palladium tetrakis(diphenyl[4-(N,N-dimethylamino)phenyl]phosphine), palladium tetrakis((2-Hydroxyphenyl)diphenylphosphine), palladium tetrakis(2-Bromophenyldiphenylphosphine), palladium tetrakis(tris(2,4,6-trimethylphenyl)phosphine)

Another object of the invention is a distillation residue comprising a solvent having a high boiling point and a palladium complex of formula (I)

$${Pd ( {PR}_{3}^{1} )}_{x} {( {PR}_{3}^{2} )}_{y} \qquad ( I )$$

wherein x is an integer comprised between 1 and 4; y is a integer comprised between 0 and 3 provided that the sum between x and y is equal to 4; each R¹, independently from each other, is a C₁-C₁₂ alkyl group, a C₁-C₁₂ alkoxy group, a C₆-C₁₂ aryloxy group or a C₆-C₁₂ aryl group; each optionally substituted by one or more of a halogen atom, a C₁₋₆ alkyl group, a C₁₋₆ alkoxy group, a hydroxy group, a N—C₁₋₆ alkylaniline group, N—C₁₋₆ alkyl-N—C₁₋₆ alkylaniline group or a C₁₋₆ halo- or perhalo hydrocarbon; each R², independently from each other, is a C₁-C₁₂ alkyl group, a C₁-C₁₂ alkoxy group, a C₆-C₁₂ aryloxy group or a C₆-C₁₂ aryl group; each optionally substituted by one or more of a halogen atom, a C₁₋₆ alkyl group, a C₁₋₆ alkoxy group, a hydroxy group, a N—C₁₋₆ alkylaniline group, N—C₁₋₆ alkyl-N—C₁₋₆ alkylaniline group or a C₁₋₆ halo- or perhalo hydrocarbon; and provided that PR¹₃ is different from PR²₃.

The solvent having a high boiling point is as defined above.

Unless specified otherwise, all percentages refer to percent by weight, based on the total weight of the referenced composition.

Typical manners to execute the invention's process are reported herein below in the examples.

### EXAMPLES

The invention will now be described in further detail by way of the following examples, wherein the abbreviations have the usual meaning in the art, the temperatures are indicated in degrees centigrade (° C.). The preparation of precatalysts and ligands solutions were carried out under an inert atmosphere (Argon) using standard Schlenk techniques. The solvents were dried by conventional procedures and distilled under an argon atmosphere. NMR spectra were recorded at 20° C. on Bruker AV 300, AV 400, or AV 500 MHz spectrometers. Chemical shifts are reported in ppm relative to solvent signals (chloroform, δ_{H}=7.26 ppm, δ_{C}=77.0 ppm). The signal assignment was ensured by recording ¹H, ¹H-COSY, -NOESY, ¹³C, ¹H-HSQC and -HMBC experiments.

### Example 1

Method for Recovering [Pd(PPh₃)₄] from a Reaction Mixture Comprising Homogeneous Palladium Complex

80 g of residues containing 3100 ppm of the homogeneous palladium complex (Residues obtained by flash distillation of a crude containing palladium complex traces. Distillation done under vacuum over a high boiling solvent) were stirred at 80° C. for 2 hours with 4.0 g (6.5 eq.) of triphenylphosphine under nitrogen. After cooling to 30° C., 30 g of heptane is added to mixture. The suspension was transferred onto a fritted filter under nitrogen, washed with 30 g of heptane, 30 g of methanol and 30 g of heptane. After drying under vacuum, 2.57 g of palladium tetrakis(triphenylphosphine) were obtained (94.7 mol % yield).

1. A method for recovering palladium in a form of a palladium complex of formula (I)
$${Pd ( {PR}_{3}^{1} )}_{x} {( {PR}_{3}^{2} )}_{y} \qquad ( I )$$
wherein x is an integer comprised between 1 and 4; y is a integer comprised between 0 and 3 provided that the sum between x and y is equal to 4; each R¹, independently from each other, is a C₁-C₁₂ alkyl group, a C₁-C₁₂ alkoxy group, a C₆-C₁₂ aryloxy group or a C₆-C₁₂ aryl group; each optionally substituted by one or more of a halogen atom, a C₁₋₆ alkyl group, a C₁₋₆ alkoxy group, a hydroxy group, a N—C₁₋₆ alkylaniline group, N—C₁₋₆ alkyl-N—C₁₋₆ alkylaniline group or a C₁₋₆ halo- or perhalo hydrocarbon; each R², independently from each other, is a C₁-C₁₂ alkyl group, a C₁-C₁₂ alkoxy group, a C₆-C₁₂ aryloxy group or a C₆-C₁₂ aryl group; each optionally substituted by one or more of a halogen atom, a C₁₋₆ alkyl group, a C₁₋₆ alkoxy group, a hydroxy group, a N—C₁₋₆ alkylaniline group, N—C₁₋₆ alkyl-N—C₁₋₆ alkylaniline group or a C₁₋₆ halo- or perhalo hydrocarbon; and provided that PR¹₃ is different from PR²₃;
from a reaction mixture comprising a homogeneous palladium complex; said method comprises the steps of
a) adding to the reaction mixture at least one phosphine of formula PR¹₃ wherein R¹ as the same meaning as defined above and optionally another phosphine of formula PR²₃ wherein R² as the same meaning as defined above;
b) distilling the reaction mixture obtained from step a) to obtain a distillate and a distillation residue; and
c) filtrate the distillation residue to obtain the palladium complex of formula (I).

2. A method for recovering palladium in a form of a palladium complex of formula (I)
$${Pd ( {PR}_{3}^{1} )}_{x} {( {PR}_{3}^{2} )}_{y} \qquad ( I )$$
wherein x is an integer comprised between 1 and 4; y is a integer comprised between 0 and 3 provided that the sum between x and y is equal to 4; each R¹, independently from each other, is a C₁-C₁₂ alkyl group, a C₁-C₁₂ alkoxy group, a C₆-C₁₂ aryloxy group or a C₆-C₁₂ aryl group; each optionally substituted by one or more of a halogen atom, a C₁₋₆ alkyl group, a C₁₋₆ alkoxy group, a hydroxy group, a N—C₁₋₆ alkylaniline group, N—C₁₋₆ alkyl-N—C₁₋₆ alkylaniline group or a C₁₋₆ halo- or perhalo hydrocarbon; each R², independently from each other, is a C₁-C₁₂ alkyl group, a C₁-C₁₂ alkoxy group, a C₆-C₁₂ aryloxy group or a C₆-C₁₂ aryl group; each optionally substituted by one or more of a halogen atom, a C₁₋₆ alkyl group, a C₁₋₆ alkoxy group, a hydroxy group, a N—C₁₋₆ alkylaniline group, N—C₁₋₆ alkyl-N—C₁₋₆ alkylaniline group or a C₁₋₆ halo- or perhalo hydrocarbon; and provided that PR¹₃ is different from PR²₃;
from a reaction mixture comprising a homogeneous palladium complex; said method comprises the steps of
i) distilling the reaction mixture comprising the homogeneous palladium complex to obtain a distillate and a distillation residue;
ii) adding to the distillation residue at least one phosphine of formula PR¹₃ wherein R¹ as the same meaning as defined above and optionally another phosphine of formula PR²₃ wherein R² as the same meaning as defined above;
iii) mixing the distillation residue comprising phosphine obtained from step ii) to obtain a distillation residue comprising the palladium complex of formula (I); and
iv) filtrate the distillation residue comprising the palladium complex of formula (I) to obtain the palladium complex of formula (I).

3. The method according to claims 1 or 2, wherein the distillation is performed in the presence of a solvent having a high boiling point.

4. The method according to any one of claims 1 to 3, wherein x is 4 and y is 0.

5. The method according to any one of claims 1 to 4, wherein each R¹, independently from each other, is a C₁-C₆ alkyl group, a C₁-C₆ alkoxy group, a C₆-C₁₀ aryloxy group or a C₆-C₁₀ aryl group; each optionally substituted by one or more of a halogen atom, a C₁₋₄ alkyl group, a C₁₋₄ alkoxy group, a hydroxy group, a N—C₁₋₄ alkylaniline group, N—C₁₋₄ alkyl-N—C₁₋₄ alkylaniline group or a C₁₋₄ halo- or perhalo hydrocarbon.

6. The method according to any one of claims 1 to 5, wherein each R¹, independently from each other, is a methyl group or a phenyl group optionally substituted by one or more of a halogen atom, a C₁₋₄ alkyl group, a C₁₋₄ alkoxy group, a hydroxy group, a N—C₁₋₄ alkylaniline group, N—C₁₋₄ alkyl-N—C₁₋₄ alkylaniline group or a C₁₋₄ halo- or perhalo hydrocarbon.

7. The method according to any one of claims 1 to 6, wherein PR¹₃ is triphenyl phosphine.

8. The method according to any one of claims 1 to 7, wherein the reaction mixture comprising a homogeneous palladium complex is coming from a reaction catalysed by a homogeneous palladium (0), palladium (I) or palladium (II) complex.

9. The method according to any one of claims 1 to 8, wherein the homogeneous palladium (II) complex is selected from the group consisting of palladium acetate; palladium acetylacetonate, allylpalladium chloride dimer, crotylpalladium chloride dimer, cinnamylpalladium chloride dimer, dihalobis(acetonitrile)palladium, dihalo-bis(benzonitrile)palladium, dichlorobisphosphinepalladium, diphosphine palladium acetate, dichlorodiphosphinepalladium, dihalo(1,5-cyclooctadiene)palladium and dihalo(1,10-phenanthroline)palladium; the homogeneous palladium (0) complex is selected from the group consisting of palladium tetrakistriarylphosphine, palladium diphosphine, palladium triphosphine, bis(dibenzylideneacetone)palladium and tris(dibenzylideneacetone)dipalladium; the homogeneous palladium (I) complex is selected from the group consisting of monophosphine palladium halide dimer.

10. The method according to any one of claims 1 to 9, wherein palladium complex of formula (I) obtained after the filtration is further washed with organic solvent.

11. The method according to any one of claims 1 to 10, wherein the method of the invention is performed in absence of base, additive, reductive agent or oxidative agent.

12. A distillation residue comprising a solvent having a high boiling point and a palladium complex of formula (I)
$${Pd ( {PR}_{3}^{1} )}_{x} {( {PR}_{3}^{2} )}_{y} \qquad ( I )$$
wherein x is an integer comprised between 1 and 4; y is a integer comprised between 0 and 3 provided that the sum between x and y is equal to 4; each R¹, independently from each other, is a C₁-C₁₂ alkyl group, a C₁-C₁₂ alkoxy group, a C₆-C₁₂ aryloxy group or a C₆-C₁₂ aryl group; each optionally substituted by one or more of a halogen atom, a C₁₋₆ alkyl group, a C₁₋₆ alkoxy group, a hydroxy group, a N—C₁₋₆ alkylaniline group, N—C₁₋₆ alkyl-N—C₁₋₆ alkylaniline group or a C₁₋₆ halo- or perhalo hydrocarbon; each R², independently from each other, is a C₁-C₁₂ alkyl group, a C₁-C₁₂ alkoxy group, a C₆-C₁₂ aryloxy group or a C₆-C₁₂ aryl group; each optionally substituted by one or more of a halogen atom, a C₁₋₆ alkyl group, a C₁₋₆ alkoxy group, a hydroxy group, a N—C₁₋₆ alkylaniline group, N—C₁₋₆ alkyl-N—C₁₋₆ alkylaniline group or a C₁₋₆ halo- or perhalo hydrocarbon; and provided that PR¹₃ is different from PR²₃.
